(19) United States
(12) Patent Application Publication
(10) Pub. No.: US 2014/0222858 A1
(43) Pub. Date: Aug. 7, 2014

(54) METHODS AND SYSTEMS FOR AUTOMATED CERTIFICATE PROCESSING

(71) Applicant: Penango, Inc., Los Angeles, CA (US)

(72) Inventor: Sean LEONARD, Los Angeles, CA (US)

(73) Assignee: Penango, Inc., Los Angeles, CA (US)

(21) Appl. No.: 14/044,412

(22) Filed: Oct. 2, 2013

Related U.S. Application Data
(60) Provisional application No. 61/708,638, filed on Oct. 2, 2012.

(51) Int. Cl. G06F 17/30

(52) U.S. Cl. CPC G06F 17/30424
USPC 707/769

(57) ABSTRACT

The embodiments provide methods and systems for facilitating sending and receiving authenticated and encrypted messages end-to-end on a network, such as the Internet, with standards-based, interoperable protocols from a variety of client platforms. In one embodiment, the methods and systems provide for automating certificate selection, validation, and sorting. Some embodiments support LDAP for automatic certificate lookup in very extensive ways. In particular, one embodiment implements a comprehensive protocol that maximizes the chances of finding certificates automatically.

### CROSS-REFERENCE TO RELATED APPLICATIONS

The present application claims priority to U.S. Provisional Application Ser. No. 61/708,638, filed Oct. 2, 2012, entitled “METHODS AND SYSTEMS FOR AUTOMATED CERTIFICATE PROCESSING,” which is herein incorporated by reference in its entirety.

### FIELD

The present disclosure relates to computer security, and more particularly, it relates automating various aspects of certificate processing.

### BACKGROUND

Network security is one of the most challenging issues facing information technology systems, especially those systems that utilize the Internet. Conventionally, security systems will employ various measures, such as user ids, passwords, digital certificates, etc.

LDAP (Lightweight Directory Access Protocol) allows applications to query a well-structured, highly hierarchical database. LDAP has been widely adopted as a primary protocol to provide access to certificates. Many organizations, for example, use it to store X.509 certificates, together with user profiles and access credentials.

### BRIEF DESCRIPTION OF THE DRAWINGS

The accompanying drawings, which are incorporated in and constitute a part of this specification, illustrate several embodiments of the disclosure and together with the description, serve to explain the principles of the disclosure.

FIG. 1 shows an exemplary screen shot of a webmail screen and that a certificate is lacking for an intended recipient.

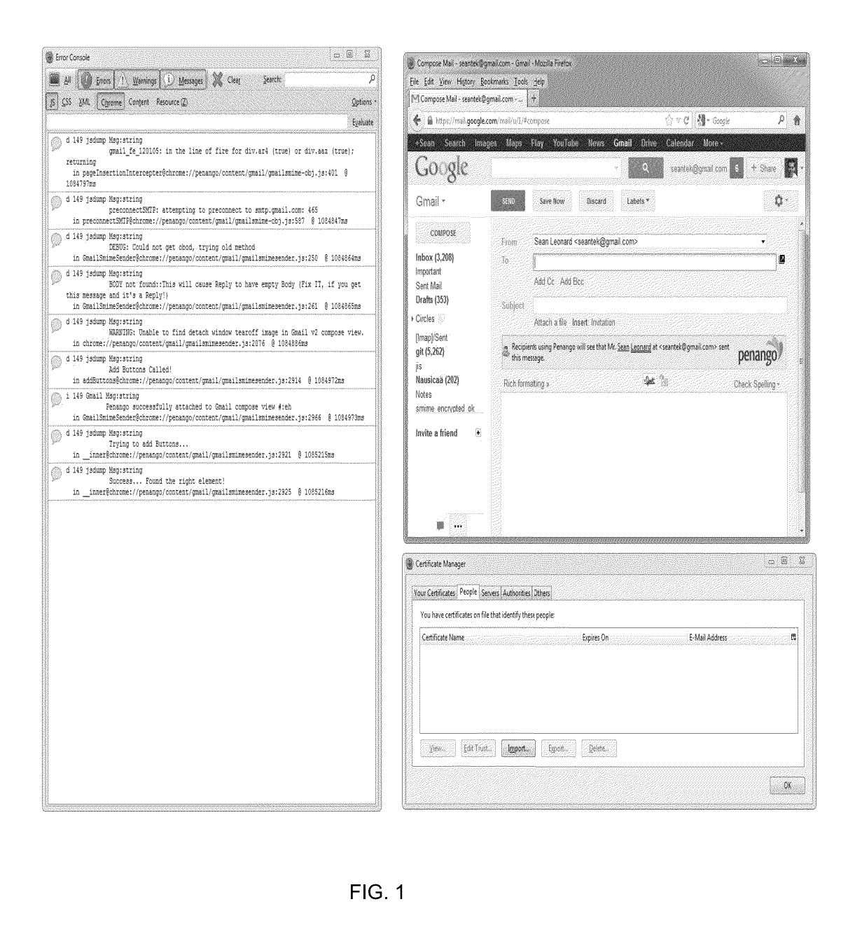

FIG. 2 shows an exemplary screen shot of the webmail screen with an email address entered.

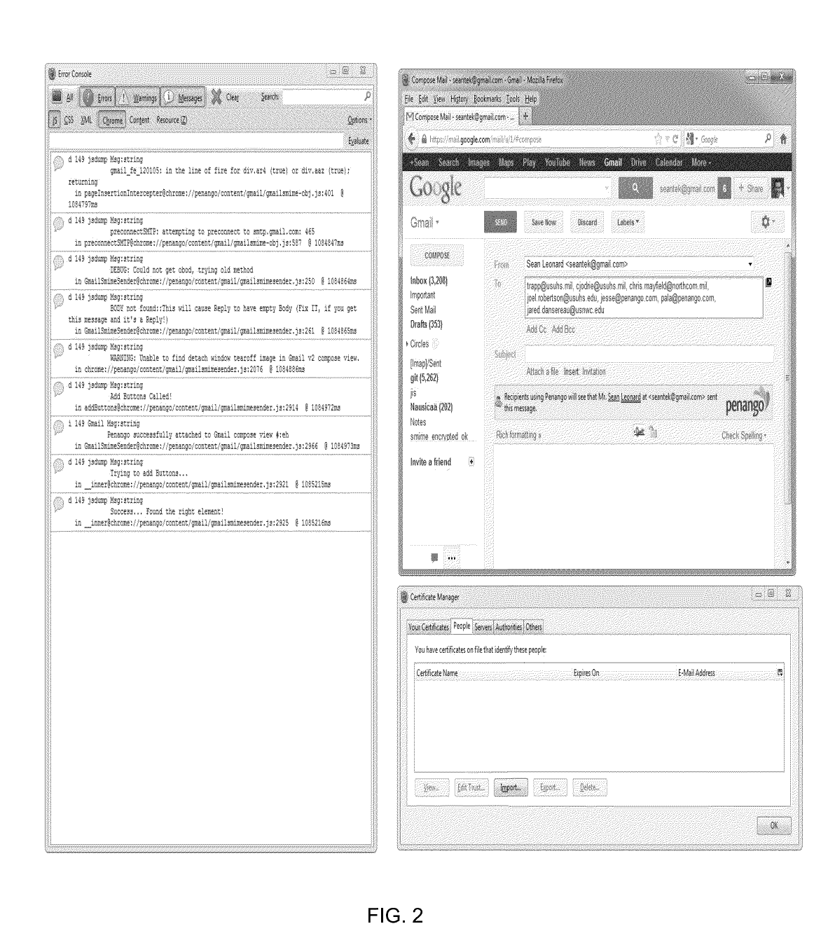

FIG. 3 shows an exemplary screen shot of the webmail screen after a user has changed fields and triggering retrieval of a certificate for the intended recipient.

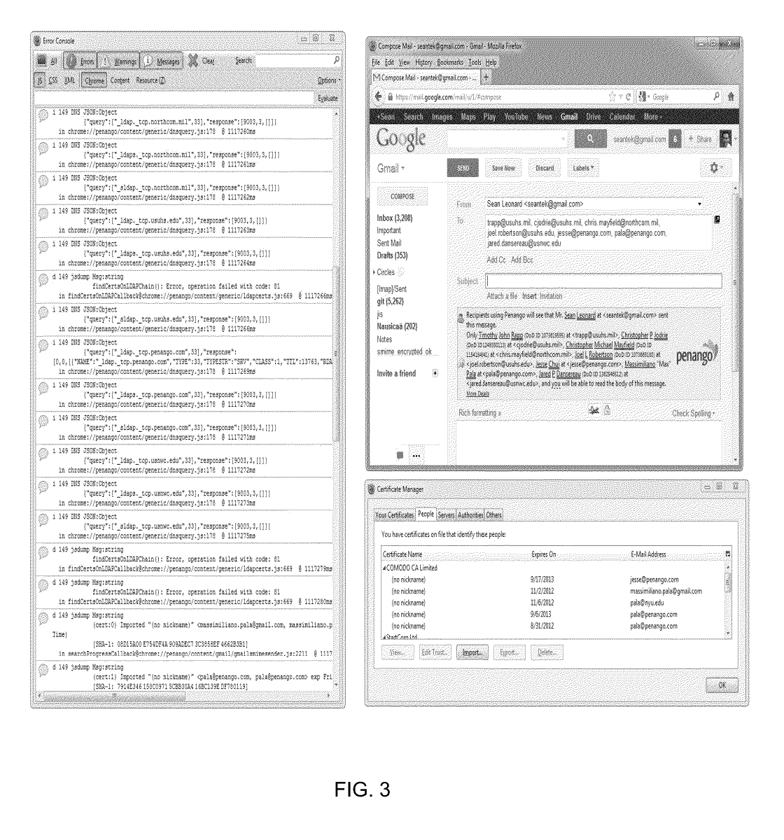

### DESCRIPTION OF THE EMBODIMENTS

The embodiments relate to a suite of software components and services that let anyone send and receive authenticated and encrypted messages end-to-end on the Internet with standards-based, interoperable protocols from a variety of client platforms. For example, the embodiments can provide for automating certificate selection, validation, and sorting.

The embodiments support LDAP for automatic certificate lookup in very extensive ways. In particular, one embodiment implements a comprehensive protocol that maximizes the chances of finding certificates automatically.

The embodiments provide a comprehensive approach to certificate processing. In conventional software, the known algorithms getBestCertByEmail and getBestUserCertByEmail were the routines that controlled which certificates were selected for signing and encrypting e-mail messages.

The embodiments try to search for all e-mail addresses on an Active Directory. If failed/not found, the methods segregate addresses into domain groups. Then, the embodiments attempt to get per-domain pre-configured information for that domain. If it exists, the embodiments only have to query the pre-configured server. If it does not exist, then the embodiments do a DNS SRV record discovery.

If DNS SRV record discovery yields LDAP information, then the embodiments use that LDAP server. But if the SRV record discovery does not yield LDAP information, then the embodiments try Idap.domain.com.

Of note, the known algorithms operate in serial. In particular, if there is pre-configured domain information, then even if that LDAP server is down or non-existent, subsequent discovery attempts will not be attempted.

In contrast, the embodiments can perform queries for certificates in parallel. For example, first the embodiments may segregate all e-mail addresses into per-domain buckets. Next, it generates LDAP Service Records (LSRs) for all of the methods (specified URLs), Active Directory, preconfigured, DNS SRV, DNS WKN). In addition, the embodiments may determine fallback LSRs as well, and add to LDAP chains. The embodiments may then execute a consolidation algorithm to consolidate LSRs that are the same, creating the union of address sets. The embodiments may run, in parallel, connections to all LSRs at the heads of the chains. If an LSR connection succeeds, the embodiments terminate that chain and do not query fallback LSRs. But if an LSR connection fails, the embodiments fall back to the next LSR in the chain, and attempt to connect. For each LSR that yields certificate data, some of the embodiments may pass that certificate data to the calling application. When all chains are complete (have been queried against), the algorithm may then end its processing.

In general, methods and systems may: gather requirements; find (dereference) identified certificates; find certificates locally; find certificates remotely; validate certificates; eliminate certificates that are invalid based on certain specified criteria, or find and validate all other certificates by addresses; eliminate invalid certs; sort certs; and use the valid certs.

When gathering requirements, this means that the application determines what exactly it is looking for. The embodiments cover many different types of operations, there are five broad use cases described below to illustrate aspects of the invention:

Find certificates with private keys for signing a message.

Find certificates for encrypting a message.

Find certificates for verifying a message.

Find private keys via certificates for decrypting a message.

Given an identification of a certificate, find the certificate that is identified by the identifier.

For finding (dereference) of identified certs, in certain cases (e.g., by local preference, by administrative policy, or by the data in a CMS structure), certificates are already identified. For example, a user may choose a specific certificate to use for signing in a dialog box. In such cases, “finding” relates to dereferencing the identifier to obtain a certificate object. In particular, if the user specifies a certificate with precision, that certificate may be available locally. In one embodiment, the certificates can be specified by their DER-encoded octets, eliminating the possibility of denial of service.

To find (valid) certs by addresses, the methods and systems attempt to find other certificates by issuing a (search) query based on desired addresses, such as an e-mail address or XMPP instant messaging address. The document “Finding Valid Certificates by Addresses” (formerly “Asynchronous Certificate Validation Design”) specifies this algorithm in detail. This document covers the finding, the calling of the validation algorithm, and the post-processing that is done with the log after validation completes (but before the find-valid operation completes).

The certificates found may then be validated. In one embodiment, certs cannot be further processed until they are validated. In the one embodiment, the Certification Path Validation Algorithm is employed. Additionally, the embodiments provide a platform-neutral API for other subsystems (such as the PAG) to get meaningful information out of the platform-specific data.

Next, the certificates may be sorted. After certificates are found and validated, they may be presented to the user or to other subsystems in a meaningful way. The goal is to sort the validated certificates so that more important, relevant, or useful certificates—or info about the certificates (as the PAG calls them)—are prioritized and displayed ahead of lesser ones. In some embodiments, the sort process can disable or force the use of particular certificates in addition to merely sorting them.

Certificates, including their validation results and various other certificate-related properties, such as whether the cert is selected or will be used, are stored for messages being composed, or for messages being read. Collectively, this state information can be consumed by other subsystems, for displaying certificates, the CMS processing subsystems for processing certificates, and performing cryptographic operations, and the S/MIME sending subsystems for generating and sending valid S/MIME messages on-the-wire.

Some embodiments may provide for asynchronous implementation. In particular, program code or software that could possibly access the network should be asynchronous. Access to the network may refer to sending or receiving data to systems over TCP/IP. This includes “localhost”, but excludes file system access (even though a file accessed through the file system could be on a non-local area network, and in general, the APIs that browsers and operating systems provide for files account for latency, e.g., on the order of milliseconds.

In the embodiments, there are no hard and fast rules regarding long computations or local data access. Certificate processing is generally thought to access the network, and therefore, is implemented asynchronously as a whole. However, certain components may operate synchronously, because they are known not to access the network. For purposes of illustration, some exemplary implementations are described below.

In one embodiment, the algorithm is implemented in the main LDAP function findCertsWithLDAP( ), which is the outer shell to the LDAP subsystem.

Developers may use findCertsWithLDAP( ) when interacting with the LDAP subsystem if no special case is made to use a different function. The algorithm runs a series of steps that identify sources, query sources for LDAP connection information (LSRs, defined below), consolidate duplicates, run the LDAP queries, and deliver certificate results.

For example, for each domain, identify all LDAP configs (LSRs) in chains. Identify and consolidate LSRs in the 2D array of LDAP chains “the consolidation algorithm”. If a set Sa of e-mail addresses is shall be queried for on LSR1, and a set Sb of e-mail addresses shall be queried for on LSR2, and LSR1==LSR2,

Then: consolidate into LSR′ with U(Sa, Sb)==S′. I.e., the set of e-mail addresses is the union of the sets that were consolidated. LSR′ replaces the LSR that was at the head of a chain, if one of the replaced LSRs is not at the head of a chain.

Next, the heads of each chain shall be queried in parallel with the heads of all other chains, for all domains at once.

For example: A search for 1@usuhs.edu, 2@usuhs.edu, 3@army.mil, 4@army.mil, 5@server.com, 6@server.com. In this example, it is known that usuhs.edu and army.mil have the GDS server, which has priority.

And, it is known (for the sake of argument) that there is a server, myldap.useful.server.net, that covers usuhs.edu and server.com. And, server.com is covered by Idap.servercom.

{
{usuhs.edu: [1, 2]} [GDS, myldap.useful.server.net]
{army.mil: [3, 4]} [GDS]
{server.com: [5, 6]} [myldap.useful.server.net, ldap.server.com]
}

Running the consolidation algorithm, the query GDS for {usuhs.edu [1,2]} and {army.mil [3,4]} and query myldap.useful.server.net for {usuhs.edu [1,2]} AND {server.com [5,6]}. THEN, if myldap fails, query Idap.servercom for {server.com [5,6]} in parallel, at the same time.

In one embodiment, the LDAP implementation introduces a new JSON type, called LDAP Service Record (LSR). An LDAP Service Record (JSON) (LSR) is a JSON object as follows:

{
host: “ldap.foo.com”,
port: 389,
secure: “none”/“ldaps”/“starttls”,
base: “o=Foo Corp,c=US”
}

Notably, the value set in the secure property does not imply any value in the port property. An LSR is complete in and of itself—no assumptions are made and no values are implied. The base DN must be a string or null.

In one embodiment, findCertsWithLDAP proceeds in several distinct steps, drawing from various sources. The steps comprise a pipeline that creates and executes LDAP queries based on LSRs, with certificate bytes as output. During the execution of the steps, duplicate LDAP queries are consolidated or eliminated based on past results.

E-mail addresses can be grouped by domain. LDAP servers are mostly domain-specific. Accordingly, the e-mail addresses passed to findCertsWithLDAP can be divided into groups based on their domains.

Next, sources are identified. Sources can be identified based on built-in configuration information. In the first iteration of this algorithm, the sources may be hardcoded.

Query sources for configurations may come from a number of locations. Each source is defined by a function that can return a query object asynchronously. The query object is a fallback list of LSRs, plus an array of addrspecs that will be searched for when querying the LDAP servers.

The format of an LDAP query object can be as follows:

{
addrspecs: Array of AddrSpec,
configs: Array of LSR
}

In one embodiment, the embodiments can maintain a “master chain” of all query objects. When the chain is exhausted and the algorithm is not waiting for further callbacks from lower-level operations, the algorithm signals completion.

Duplicate LSRs can then be consolidated. It is possible that sources can offer the same LSR. Based on the consolidation algorithm, these duplicate queries are consolidated into a single query to improve performance and reduce redundant queries. The various LSRs are then executed.

Return certificate data via a callback is provided to findCertsWithLDAP. In one embodiment, the certificate data is provided in DER form as octet strings.

When no further LSRs remain to be queried, the callback provided to findCertsWithLDAP is called with no arguments. This step signals completion of the algorithm.

Specified URLs can specify a source. Specified URLs allows the user to specify LDAP services in fallback order. The preference is a single LDAP URL, or a list of LDAP URLs, as discussed below. For each of the provided URLs, an LSR is built and added to the list of queries. The specification may be on a per-domain basis. The configurations will be queried in

the order that they appear. In the above example if contacting the first URL fails, the second will be queried. This process proceeds until a successful search is performed or the list of configurations is exhausted.

Another source is the active directory. This source generates a query to the local Active Directory. On Windows systems, this source translates to a Winldap query by using NULL as the hostname. On non-Windows systems (if OpenLDAP is used) this results in a query to localhost.

Default Configurations as a source. In the embodiments, default configurations for well-known LDAP-enabled domains is provided, such as domains affiliated with the Global Directory Services. If found, the configurations are used to build new LSRs for LDAP querying.

The embodiments also provided for automatic discovery via SRV and WKN DNS search. In the embodiments, the software may use DNS SRV records and Well-Known Names Names (WKNs) as additional discovery methods. In particular, for each recipient's domain, the WKN approach uses “Idap.”+domain to build additional LDAP queries. The embodiments will also attempt to discover if any configuration information is available through the DNS subsystem. In order to retrieve possible LDAP configurations, the methods and systems may query the DNS for three different SRV records, in parallel:
“_Idaps._tcp.”+domain (LDAP over SSL/TLS)
“_sldap._tcp.”+domain (LDAP with STARTTLS)
“_Idap._tcp.”+domain (non-secure connection)

Since the DNS queries can return multiple records for the same domain, the records are sorted according to RFC 2782 priority and weight order. Categorically, LDAPS records may be preferred over SLDAP records, which are preferred over LDAP records. Each SRV record results in a distinct LSR, which is then added to the LDAP querying pipeline.

For example, if a search is performed for: \_Idap.\_tcp.domain.com and the DNS returns the following SRV records:

1. 100 100 389 Idap1.domain.com

2. 200 100 389 Idap2.domain.com

3. 100 200 389 Idap3.domain.com

The LDAP subsystem will build three LSRs that will be queried, for example, sequentially: 1., 3., then 2.

WKNs will be generated only if no SRV records exist for LDAPS, SLDAP, or LDAP.

An attacker can mount a MITM attack if the attacker tampers with DNS or LDAP communications on the wire. For example, if an embodiment resorts to plain LDAP (no SSL/TLS), an attacker can see the query containing e-mail addresses, and can manipulate the results. Similarly, even if LDAPS is used, if the DNS SRV information is manipulated, an embodiment of the software can be redirected to query the wrong LDAP server. Overall, the risk of disclosure is very minimal (e-mail addresses will eventually appear in the headers of e-mail messages). Even if an attacker can acquire a “rogue” certificate, the embodiments will not use the certificate if it does not validate.

There are three mitigations for MITM attacks: 1. Only run an LDAP server with SSL/TLS. 2. Set the DNS SRV record for _Idaps or _sldap. 3. Implement DNSSEC so that the SRV record can be authenticated. In one embodiment, the software itself does not implement DNSSEC. It is up to the platform's native client library, or the upstream DNS resolver (which may be considered “trusted”), to validate records with DNSSEC.

For domains without directories, the embodiments may comprise a list of domains that are known to lack LDAP servers. If the domain is on the aforementioned list of forbidden domains, it means that neither WKN nor SRV record based DNS discovery methods will execute. One embodiment implements the forbidden domains by changing the default preference from true to false for these domains. Therefore, if a local preference exists with the value of true, it will override the default false for the forbidden domain. The local preference that is not parameterized by vars affects all domains, including forbidden domains. Thus, setting the non-parameterized preference to true will cause one embodiment to attempt discovery on all domains, including the well-known public ones that are known to lack

One embodiment makes use of four different preferences to control how sources produce LSRs. All LSRs are parameterized by the vars “domain”, such as •urls (string)—Default: “ ”.

Administrators and users can provide their own configurations for well known domains. This preference should carry one or more LDAP URLs that one embodiment LDAP subsystem will use in preference to any other discovered LSR. Each LDAP URL may be separated by angle brackets ‘< . . . >’ and starting with the left angle bracket ‘<’: <Idap://Idap1.domain.com:389><Idaps://Idap2.backup.com/?o=org>•useAD (boolean)—Default: true.

When set to true, this preference enables querying the local Active Directory server (if available). It is equivalent to querying using a NULL hostname with Idap_init( ). However, Active Directory querying will attempt to log in, which translates to GSS-SPNEGO authentication with Winldap. This preference is useful for systems that are joined in a Windows domain.

OpenLDAP-based systems will replace NULL with localhost. •useDefaultConfigs (boolean)—Default: true. This preference enables one embodiment to have embedded LDAP configurations. In particular, one embodiment may lookup the configurations listed in the generic/Idap-configs.js file for a match for any of the domains of the recipients. If one or more matching configurations are found (LSRs), One embodiment will query those servers as well.
•useDiscovery (boolean)—Default: true. When this preference is set (true), one embodiment will try to automatically discover server configurations for each of the domains of the recipients. The approach may be twofold:

1. DNS SRV record lookup. One embodiment is capable of querying the DNS and asking for DNS SRV records associated with a particular domain. If the DNS query returns valid records, One embodiment will query the returned hostnames in sequence. 2. Well Known Names. One embodiment will add an LDAP query for the “Idap”. domain hostname.

In one embodiment, a consolidation algorithm is performed. The consolidation algorithm is for duplicates (both in terms of domain and e-mail addresses) and aggregate them.

As new LSRs are provided by the sources, they may be executed immediately or deferred for imminent execution. However, this algorithm anticipates that sources will provide duplicative LSRs in many cases. For example, the user may specify the URL “Idaps://Idap.domain.com” for domain.com, while the SRV record for Idaps.tcp.domain.com returns Idap.domain.com on port 636, and the internal, default configuration data also identifies Idap.domain.com with LDAP-over-SSL/TLS. In such cases, the algorithm provides a consolidation algorithm to prevent duplicative LDAP connections and searches.

LDAP query configurations can be recorded in findCertsWithLDAP( ) in an ordered array. Each query configuration identifies a set of addrspecs, plus an ordered array of LSRs to attempt in fallback order. When a source provides findCertsWithLDAP with a new configuration, the consolidation algorithm iterates over the new configuration to see if each LSR is scheduled for guaranteed execution among prior configs. Special logic may define various steps to determine when LSRs match. The LSRs may be equal, but in addition, the LSRs may be queried with some particular set of addrspecs. The newer LSR is consolidated into the earlier LSR, but when the LSR is executed, it will be searched for the union of addrspecs of both the newer LSR and the earlier LSR. If the search succeeds (including if the search returns zero results), both older and newer query configuration chains will be considered “searched”, and fallback LSRs will not be considered. However, if the search fails, then both older and newer query configuration chains will be considered “not searched”, and the fallback LSRs will be executed.

In one embodiment, the LSRs at the “heads” (the first position in the configuration LSR arrays) of configurations are considered, because only the heads are guaranteed to be executed. LSRs past the heads are not guaranteed to be executed, because if a head LSR succeeds, subsequent LSRs in the array for that configuration will not be executed.

One implementation overview will now be described below. In one embodiment, the LDAP architecture comprises a high-level JS API, a low-level platform neutral JS API, and a low-level platform-specific C++ Interface. The high-level JS API can be provided by the following files:
generic/Idapcerts.js: high-level platform-neutral API for retrieving certificates from LDAP servers. The developer may use one function to enter the LDAP calling functionalities—findCertsWithLDAP( ).
generic/Idap-configs.js: Configuration options for default LDAP servers.

These configurations are used by findCertsWithLDAP( ) to build the LDAP Service Record (LSRs) for well known LDAP servers. The low-level JS API can be coded in a single file:
generic/Idap.js: low-level platform-neutral API for interacting with LDAP servers. This file may be used to create the LDAP object and provides the low-level JS interface to the C++ LDAP libraries.

For the high-level LDAP JS API, the public LDAP JS API is comprised of the following functions for finding certificate data asynchronously and for processing LSRs.

One embodiment may use one main function for retrieving certificates from the LDAP. The function returns the number of concurrent LDAP searches spawned. This function may be JS and no C interfaces are called.

One function may be in charge of discovering the LDAP server's details by using different discovery mechanisms:
User's configured URLs
Active Directory
Default Configurations (in Idap-configs.js)
DNS SRV records
Well Known Names (WKN)

This function first builds the array of LDAP queries to be performed, then it eliminates duplicate queries and spawns the searches by calling a function. An internal counter keeps track of the number of spawned searches.

For discovery via DNS SRV, after that, if the discovery is enabled, the function proceeds to discover possible configurations from the DNS server. Since this operation requires an additional network operation, it is performed after the first batch of LDAP queries is spawned.

The DNS is queried for service records for each of the recipients' domains. If valid records are returned (and processed in the dnscallback( ) callback function), the new queries are spawned (after all the DNS searches are returned). An internal counter keeps track of the number of remaining async queries—when this reaches 0, the original callback is called with no parameters to signal the caller that all the async operations have terminated.

Also, note that—in order to provide the possibility for the caller to update the UI as soon as some operations complete—each time a search is completed, a callback function will call the caller's callback with the results of the search (if successful).

In one embodiment, a function is called when a search on an LDAP server (and possible secondary ones) is to be performed. The query is a LDAP query object. The object carries the details about the query and an array with the configuration of the servers that will be queried sequentially until a successful search was performed or the list is exhausted.

The callback will be called when the query is completed (exactly once). The code provides the status of the query. If 0, the query was successful. A return array carries the array of returned objects from the query. The caller function is responsible for parsing the results (e.g., parse the returned blobs into certificates). The function throws if the setup of the search is not successful. The function will call the callback function once, otherwise it will not do it as the spawning of the async operation failed.

Another function is called when a search on an LDAP server is required and the network configuration is known. If the passed object is a configuration, the object may have the following properties:
host (String or null). Hostname of the Idap server to bind to
port (Number). Port number, usually 389 or 636.
secure (String). One of “none”, “starttls”, “ssl”.
base (String or null). Base DN to use for the search. If null is passed, then the LDAP subsystem will use the implemented discovery mechanism for retrieving the baseDn from the LDAP server and performs searches with each of the discovered baseDNs until results are found or the list of supported baseDNs is fully processed.

If, instead, the passed object is an LDAP object, the object should be the returning value. An array with the email addresses to be searched on the LDAP.

One function acts as a gateway between JS and native code. In particular it is in charge of: generating a new LDAP object; initializing the LDAP object; build the filter string to be passed to the Idap search function; and call the Idap.bind( ) that will start the LDAP lookup process on the wire. In one embodiment, the operation is asynchronous.

Internally, the function has two callbacks for the bind and search operations: onbind( ) is the listener for the “bind” event. If an error is detected and the bind was not successful, the function will call the findCertsOnLDAP( ) function recursively if secondary configurations are available in the query.configs array.

If, on the other hand, the bind operation is successful, then the search( ) method of the Idap object is invoked. This asynchronous operation takes place in the C++ code and re-enters the JS environment via the onsearch( ) callback.

The onsearch( ) function is the listener for the “search” event. The function internally calls a function and the callback once the results from the search are returned. If the search was successful and it returned values, the callback from findCertsOnLDAP( ) is called with the parsed results. If an error was returned or no results were found and secondary configurations are available in the query object, the findCertsOnLDAP( ) is recursively called. Otherwise, if not additional discoveries are possible, the callback is called with the error code as the only argument. The function throws an exception in case the initialization of the LDAP is not successful.

An internal utility function parses the results of an LDAP search query, hunting for certificate data. This function returns an array of certificate blobs (octet strings).

Another function parses an LDAP URL into a JSON-based LDAP Service Record. The function returns an LSR, or null if the url is not a valid LDAP URL. The function is designed not to throw during normal usage. Valid LDAP URLs begin with “Idap”, “Idaps”, or “sldap”.

Another function parses an string into an array of LDAP Service Records. The function returns an array of LDAP Service Record (LSR) of length 1 or more. In case no valid URL are found, the function returns null.

Yet another function determines if two LDAP Service Records (JSON objects) are equal. The function returns a boolean value, and is not meant to throw. If Isr1 or Isr2 are not bona-fide LSR objects, this function returns false.

One embodiment uses LDAP APIs. The Idap.js provides a platform-neutral, uniform, JavaScript-friendly API that Perfectly Reflects™ the API defined in RFC 1853 and draft-ietf-Idapext-Idap-c-api-xx.txt.

Regarding asynchronous operations, in one embodiment, any function that could access the network may be implemented asynchronously. For example, low-level JS LDAP functions are asynchronous except for Idap.init( ). Consequently, the C++ bindings are also asynchronous. However, the implementation of the functions do not have to use the non-blocking versions of the functions.

For example, Idap.bind( ) in JS can call Idap_bind( ) OR Idap_bind_s( ) in C. However, if Idap_bind_s is called, it cannot be called from the JS thread, because the thread would block. In such a case, Idap_bind_s( ) can be called from a worker thread, which dispatches the result back to the main thread as if Idap_result( ) provided the result.

In one embodiment, the proper operation of the LDAP implementation is to have a thread pump that pumps Idap_result messages and dispatches them to the JS thread. An alternative to a message pump is per-message waiting. Unlike a single dedicated thread that waits on Idap_result for any message, in per-message waiting, a new work item is created that calls Idap_result for a specific message ID.

When a message for that particular message ID is received, the thread pool item (task) dispatches the result to JS. One advantage of this approach is that the C++ object and the worker thread(s) do not have to hold a long-lived reference to the LDAP JS object. Holding a long-lived reference to the LDAP JS object results in a circular reference: the LDAP JS object must hold a reference to the C++ object, but in order for the C++ object to notify the LDAP JS object of results, the C++ object may hold a reference to a JS callback which refers back to the LDAP JS object.

By using per-message ID waits, the work item only holds a reference to the LDAP JS object until the server responds with the results for that message. Then, the work item releases its reference, so the LDAP JS object can be destroyed “naturally” (and when the LDAP JS object is destroyed, it can release its final reference to the C++ object, so that Idap_unbind( ) is called gracefully).

While the above description contains many specific details, these specifics should not be construed as limitations on the scope of the invention, but rather as an exemplary description of the embodiments thereof. Many other variations are possible, as indicated in the additional embodiments recited above. For example, it may be appreciated that the embodiments are not limited to LDAP. Discovering and looking up materials in other directories containing contact information, including certificates, can be done on Google Contacts, Plaxo, Facebook, Zillow, various Address Book stores, Yahoo! Address Book API, Oracle and other SQL databases, ZixCorp mail databases and gateways, Identity Based Encryption (IBE)-based services like Voltage, and other types of databases.

The features and attributes of the specific embodiments disclosed above may be combined in different ways to form additional embodiments, all of which fall within the scope of the present disclosure. Although the present disclosure provides certain embodiments and applications, other embodiments that are apparent to those of ordinary skill in the art, including embodiments, which do not provide all of the features and advantages set forth herein, are also within the scope of this disclosure. Accordingly, the scope of the present disclosure is intended to be defined only by reference to the appended claims.

What is claimed is:

1. A method for automatically finding a certificate, said method comprising:
searching for e-mail addresses on an active directory responsive to a request for a certificate;
segregating addresses into domain groups;
determining per-domain pre-configured information for each domain group; and
querying a server based on the per-domain pre configured information for the requested certificate.

2. The method of claim 1, further comprising performing a DNS SRV record discovery query.

3. The method of claim 2, further comprising determining LDAP information from the SRV record discovery.

4. The method of claim 1, wherein querying the server comprises querying for certificates in parallel.
